(19) United States
(12) Patent Application Publication
(10) Pub. No.: US 2026/0248135 A1
(43) Pub. Date: Aug. 27, 2026

(54) HERBICIDAL COMBINATIONS AND A METHOD FOR CONTROLLING UNDESIRED VEGETATION

(71) Applicants: UPL Mauritius Limited, Port Louis (MU); UPL Europe Ltd., Cheshire (GB)

(72) Inventors: Giuvan Lenz, Pereiras (BR); Jessica Ferreira Lourenco Leal, Pereiras (BR); Ganesh Rao, Mumbai (IN)

(21) Appl. No.: 18/877,427

(22) PCT Filed: Jun. 23, 2023
(86) PCT No.: PCT/GB2023/051652

§ 371 Date: Dec. 20, 2024

(30) Foreign Application Priority Data
Jun. 24, 2022 (IN) 202211036380

(51) Int. Cl. A01N 57/20; A01N 43/38; A01N 43/54; A01P 13/00

(52) U.S. Cl. CPC A01N 57/20; A01N 43/38; A01N 43/54; A01P 13/00

(57) ABSTRACT

The present disclosure relates to a method for controlling unwanted vegetation/weeds. More particularly, the present disclosure relates to a method for controlling Brachiaria genus weeds with synergistic herbicidal combinations comprising L-glufosinate, salts, esters, or combinations thereof and at least one additional herbicide.

### FIELD OF THE INVENTION

The present disclosure relates to a method of controlling undesired vegetation/weeds. More particularly, the present disclosure relates to a method of controlling weeds of Brachiaria genus with synergistic herbicidal combinations and compositions of said combinations.

### BACKGROUND OF THE INVENTION

Weeds are undesirable plants that are detrimental to agriculture and significantly affect crop yields. Farmers use various types of herbicides to control weeds. Herbicides are chemical substances, which are used to specifically control the unwanted plants/weeds.

Brachiaria decumbens is a perennial plant, much tillered, upright and about 30 to about 100 centimetres (cm) tall. Its reproduction occurs through seeds, rhizomes and stolons. Its seeds can present viability for about 8 years; majority among which present initial dormancy and can germinate at several depths (about 0 cm to 8 cm). This species is difficult to control, due to the irregular and prolonged germination of the seeds. It is reported that in areas infested with Brachiaria decumbens, there may be up to 82% yield reduction in crops. As a consequence of its characteristics, its control in pre-emergence requires a herbicide with long effective period of (residual) control. In such cases, an effective herbicidal combination may hold some potential for good control over this weed. The herbicides, solo or combinations presently known are not sufficient to control resistant and persistent Brachiaria genus weeds, for example Brachiaria decumbens.

There is a constant need to develop effective herbicidal combinations to control the growth of unwanted plants/weeds. Furthermore, selective control of unwanted plants/weeds in crops is a key challenge facing modern agriculture, as the herbicides may not always result in the desired effect. Combinations of herbicides may result in an additive effect or an antagonistic effect. It may also result in phytotoxicity to the crops making it an undesirable combination. Consequently, herbicides need to be carefully selected so that they can be combined to offer a synergistic effect that would control weeds while having no phytotoxic effect on the crop and reduce the chances of the weeds developing resistance to a particular herbicide.

Therefore, there is a need in the art for a method of protecting crops from Brachiaria genus weeds using herbicidal combinations that have advantageous properties such as being synergistic, helping in resistance management, reducing dosage of herbicides used and providing improved residual effects.

### OBJECTIVES OF THE INVENTION

It is a primary objective of the present disclosure to provide a method of controlling weeds of Brachiaria genus by applying a herbicidal combination.

It is another objective of the present disclosure to provide a method of controlling weeds of Brachiaria genus, by applying a synergistic herbicidal combination comprising L-glufosinate, salts, esters, or combinations thereof and at least one additional herbicide.

It is yet another objective of the present disclosure to provide a method of controlling Brachiaria genus weeds, by applying a synergistic herbicidal combination comprising L-glufosinate, salts, esters, or combinations thereof and at least one additional herbicide selected from the group comprising protoporphyrinogen oxidase inhibitor herbicides, auxin herbicides, or combinations thereof.

It is yet another objective of the present disclosure to provide a method of controlling Brachiaria genus weeds in plants, wherein the method comprises applying a synergistic herbicidal combination comprising L-glufosinate, salts, esters, or combinations thereof and at least one additional herbicide, to a plant or a locus thereof, where undesirable vegetation occurs or is expected to occur.

It is yet another objective of the present disclosure to provide a method of increasing yield in a plant by application of a synergistic herbicidal combination.

It is yet another objective of the present disclosure to provide a method of improving the plant health by application of a synergistic herbicidal combination.

### SUMMARY OF THE INVENTION

In an aspect, there is provided a synergistic herbicidal combination for control of Brachiaria genus weeds, said combination comprising L-glufosinate, salts, esters, or combinations thereof and at least one additional herbicide.

In another aspect, there is provided a synergistic herbicidal combination for control of Brachiaria genus weeds, said combination comprising L-glufosinate, salts, esters, or combinations thereof and at least one additional herbicide selected from the group comprising:
(a) protoporphyrinogen oxidase inhibitor herbicides;
(b) auxin herbicides;
or combinations thereof.

In another aspect, there is provided a herbicidal composition for controlling Brachiaria genus weeds, wherein the composition comprises:
(a) L-glufosinate, salts, esters, or combinations thereof;
(b) at least one additional herbicide selected from the group comprising protoporphyrinogen oxidase inhibitor herbicides, auxin herbicides, or combinations thereof; and
(c) at least one agrochemically acceptable excipient.

In another aspect, there is provided use of a synergistic herbicidal combination for controlling Brachiaria genus weeds, wherein said combination comprises:
(a) L-glufosinate, salts, esters, or combinations thereof; and
(b) at least one additional herbicide selected from the group comprising protoporphyrinogen oxidase inhibitor herbicides, auxin herbicides, or combinations thereof.

In an aspect, the present disclosure provides a method of controlling Brachiaria genus weeds, the method comprising applying to a plant or a locus thereof, at which control is desired, a synergistic herbicidal combination comprising L-glufosinate, salts, esters, or combinations thereof and at least one additional herbicide.

In another aspect, there is provided a method of controlling Brachiaria genus weeds, said method comprising applying to a plant or a locus thereof, at which control is desired, a synergistic herbicidal combination comprising:
(a) L-glufosinate, salts, esters, or combinations thereof; and
(b) at least one additional herbicide selected from the group comprising protoporphyrinogen oxidase inhibitor herbicides, auxin herbicides, or combinations thereof.

### DETAILED DESCRIPTION OF THE INVENTION

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

For the purposes of the following detailed description, it is to be understood that the disclosure may assume various alternative variations except where expressly specified to the contrary. Moreover, other than in any operating examples, or where otherwise indicated, all numbers expressing, for example, quantities of materials/ingredients used in the specification are to be understood as being modified in all instances by the term “about”.

Unless otherwise defined, all technical and scientific terms used herein have the same meaning as commonly understood by one of ordinary skill in the art to which this disclosure pertains. In the case of conflict, the present document, including definitions will control. Although methods and materials similar or equivalent to those described herein can be used in the practice or testing of the disclosure, suitable methods and materials are described herein.

It is to be noted that, as used in the specification, the singular forms “a”, “an”, and “the” include plural referents unless the context clearly dictates otherwise.

The expression of various quantities in terms of “%” or “% w/w” means the percentage by weight of the total solution or composition unless otherwise specified.

The terms “comprising”, “having”, “including”, and “containing” are to be construed as open-ended terms (i.e., meaning “including, but not limited to”) unless otherwise noted.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The term “Brachiaria genus weeds” or “weeds of Brachiaria genus” in the present scope of discussion refers to a weedy soybean growing in fields wherein other crops are being grown. It may be referred to as volunteer soybean and comprises both wild-type or recombinant varieties of soybean. The term also includes resistant varieties of soybean to other herbicides. The resistant varieties may be naturally developed or genetically engineered to demonstrate the resistance phenotype. That is, Brachiaria genus weeds is a weed as it is not the target crop. Brachiaria genus weeds means all the species falling within genus Brachiaria in the family Poaceae and comprises species such as Brachiaria africana, weedy Brachiaria coracona, Brachiaria floccifolia, Brachiaria decumbens, Brachiaria intermedia, Brachiaria jaegeri, Brachiaria kigeziensis, Brachiaria multiflora, Brachiaria semisterilis, Brachiaria tristachya, or combinations thereof.

The term “herbicide” as used herein denotes a compound which controls or modifies the growth of undesired weeds.

The term “herbicidally effective amount” indicates the quantity of such a compound or combination of such compounds which is capable of producing a controlling or modifying effect on the growth of harmful plants. Controlling effects include all deviation from natural development, for example: killing, retardation, leaf burn, albinism, dwarfing, etc.

The term “plants” refers to all physical parts of a plant, including seeds, seedlings, saplings, roots, tubers, stems, stalks, foliage and fruits.

The term “locus” refers to an area of planted crops or a location where Brachiaria genus weeds occurs or grows or can occur or grow and is intended to include soil, medium of growth other than soil.

As used herein, the terms “undesirable vegetation”, “undesirable species”, “undesirable plants”, “harmful plants”, “undesirable weeds”, “harmful weeds” or “weed” are synonyms and particularly refer to Brachiaria genus and species.

The terms “g a.i./L” as used herein denotes the concentration of the respective active ingredient in “grams” present “per litre” of the composition. The terms “g ai/L”, “g a.i./L” and “g/L” may be used interchangeably.

The terms “g a.i./ha” as used herein denotes the concentration of the respective active ingredient in “grams” applied “per hectare” of the crop field. The terms “g ai/ha”, “g a.i./ha” and “g/ha” may be used interchangeably.

As used herein, the term “inorganic salt” refers to salts of glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, —NH₂(CH₃)(C₂H₄OH)⁺ salt, glufosinate-ammonium, glufosinate-sodium, glufosinate-potassium, glufosinate-calcium, or combinations thereof.

As used herein, the term “about” refers to a measurable value such as a parameter, an amount, a temporal duration, and the like and is meant to include variations of ±15% or less, specifically variations of ±10% or less, more specifically variations of ±5% or less, even more specifically variations of ±1% or less, and still more specifically variations of ±0.1% or less of and from the particularly recited value, in so far as such variations are appropriate to perform in the disclosure described herein. Furthermore, it is also to be understood that the value to which the modifier “about” refers is itself specifically disclosed herein.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or plant growth promoting agents, adjuvants, or excipients not specifically recited therein.

The term “control” relates to a weed, includes control of the weed, as well as protecting a plant, a portion of the plant, or a plant seed from attack or invasion by said weed.

As used herein, the term “pre-emergence” or “before emergence” refers to the time point before seedlings emerge from the ground. When any herbicide is applied at pre-emergence stage, it prevents establishment of the germinated weed seedlings.

As used herein, the term “post-emergence” refers to the time point after seedlings emerge from the ground. When any herbicide is applied at post-emergence stage, it prevents growth of the germinated weed seedlings.

Glufosinate (also known as phosphinothricin; DL-homoalanin-4-yl(methyl)phosphinic acid) is a racemic phosphinico amino acid (Hoerlein, G. 1994; Glufosinate (Phosphinothricin), a natural amino acid with unexpected herbicidal properties. Rev. of Environmental Contamination and Toxicology 138, 73-145). Its ammonium salt (glufosinate-ammonium) is widely used as a non-selective herbicide. The L-isomer of glufosinate is a structural analogue of glutamate and, therefore, is a competitive inhibitor of the enzyme glutamine synthetase (GS) of bacteria and plants (Bayer et al, 1972, Phosphinothricin and phosphinothricyl-alanyl-alanin. Helv. Chim. Acta 55, 224-239; Leason et al., 1982, Inhibition of pea leaf glutamine synthetase by methioninsulfoximine, Phosphinothricin and other glutamate analogs. J. Phytochem. 21, 855-857). The chemical structures of D-glufosinate and L-glufosinate are represented as below.

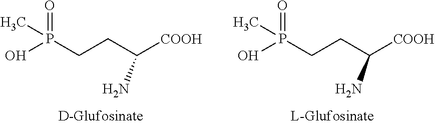

As used herein, the term “glufosinate” refers to any molecule which is a racemic phosphinico amino acid. The term also includes salts, forms such as solvates, hydrates, anhydrous form, crystalline form, polymorph forms, pseudo polymorph forms, amorphous form or mixture thereof, and sodium, potassium or ammonium salts. The salts of glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition. The agronomically acceptable salts include glufosinate-ammonium, glufosinate-sodium, glufosinate-potassium, or combinations thereof.

As used herein, the term “L-glufosinate” or “Glufosinate-P” refers to the L-isomer of Glufosinate, a salt and an ester thereof. The L-isomer of glufosinate is a structural analogue of glutamate and, therefore, is a competitive inhibitor of the enzyme glutamine synthetase (GS) of bacteria and plants. The L-enantiomer of glufosinate acts by inhibition of glutamine synthetase thereby causing accumulation of toxic levels of ammonium ion and indirectly stopping photosynthesis. It is also known as phosphinothricin or(S)-2-amino-4-(hydroxy(methyl)phosphonoyl) butanoic acid. The term can generically refer to any form of L-glufosinate such as solvates, hydrates, esters, anhydrous form, polymorph forms, pseudo polymorph forms, amorphous form, or mixture thereof, and sodium, potassium or ammonium salts. The salts of L-glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition. The agronomically acceptable salts include L-glufosinate-ammonium (Glufosinate-P-ammonium), L-glufosinate-sodium, and L-glufosinate-potassium. The term may also refer to an isomeric (racemic) mixture of L-glufosinate, D-glufosinate and salts thereof, wherein the content of L-glufosinate in the mixture is about 70% or greater, preferably about 80% or greater and more preferably about 90% or greater. Typically, the ratio of L-glufosinate: D-glufosinate can be in the range from about 90:10 to about 99.9:0.1, preferably from about 95:5 to about 99.9:0.1.

Discussed below are some representative embodiments of the present disclosure. The disclosure in its broader aspects is not limited to the specific details and representative methods. Illustrative examples are described in this section in connection with the embodiments and methods provided.

An effective weed control can be achieved by usage of herbicides appropriately. The activity of herbicides can be enhanced in various ways to achieve the maximum benefit. One of the ways is to use herbicides with different herbicidal combinations. However, identifying appropriate combinations, their agrochemical application rates, and ratio of the combinations is essential to achieve efficacious control, which is not straight forward.

Accordingly, the present disclosure provides a method for partially or completely controlling harmful weeds with a combination of two or more herbicides.

Accordingly, the present disclosure provides a method for partially or completely controlling harmful weeds with a herbicidal combination.

Accordingly in an embodiment, the present disclosure provides a herbicidal combination.

In another embodiment, the present disclosure provides a herbicidal combination comprising L-glufosinate, salts, esters, or combinations thereof and at least one additional herbicide.

As used throughout the disclosure, L-glufosinate and the additional herbicide, includes their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods.

More particularly, the present disclosure provides a method of controlling weeds of Poaceae family with synergistic herbicidal combinations and compositions of said combinations.

More particularly, the present invention relates to a method of controlling weeds of Brachiaria genus with synergistic herbicidal combinations and compositions of said combinations.

In an aspect, the present invention provides a method of controlling Brachiaria genus weeds, with synergistic herbicidal combinations and compositions comprising said combinations.

It has been found by the inventors of the present invention that Brachiaria genus weeds, can be controlled using the combination comprising L-glufosinate, salts, esters, or combinations thereof and at least one additional herbicide selected from group comprising:
(a) protoporphyrinogen oxidase inhibitor herbicides;
(b) auxin herbicides;
or combinations thereof.

It was found that in present combinations, L-glufosinate, salts, esters, or combinations thereof and at least one additional herbicide, provided a synergistic effect in controlling Brachiaria genus weeds. The degree of synergistic enhancement in the efficacy of the above combinations towards control of Brachiaria genus weeds, was unpredictable and unexpected. Moreover, the properties and advantages mentioned are required in practical weed control to keep agricultural crops free of unwanted competing plants, and thus to qualitatively and quantitatively ensure and/or increase the yield in plants.

Accordingly, the present disclosure provides a method for partially or completely controlling harmful weeds with a synergistic herbicidal combination.

Accordingly, the present disclosure provides a method for partially or completely controlling Brachiaria genus weeds with a synergistic herbicidal combination.

Accordingly in an embodiment, the present disclosure provides a synergistic herbicidal combination.

In another embodiment, the present disclosure provides a synergistic herbicidal combination comprising L-glufosinate, salts, esters, or combinations thereof and at least one additional herbicide.

The present disclosure, therefore, provides a synergistic herbicidal combination for controlling Brachiaria genus weeds, wherein the combination comprises L-glufosinate and at least one additional herbicide selected from the group comprising:
(a) protoporphyrinogen oxidase inhibitor herbicides;
(b) auxin herbicides;
or combinations thereof.

The present disclosure provides a synergistic herbicidal combination for controlling Brachiaria genus weeds, wherein the combination comprises L-glufosinate, salts, esters, or combinations thereof and at least one additional herbicide selected from the group comprising:
(a) protoporphyrinogen oxidase inhibitor herbicides;
(b) auxin herbicides;
or combinations thereof.

In a preferred embodiment, the Brachiaria genus weeds is Brachiaria decumbens.

In a preferred embodiment, the weed of Brachiaria genus is Brachiaria decumbens.

In an embodiment, the salt comprises an inorganic salt of L-glufosinate.

In an embodiment, the inorganic salt of L-glufosinate is selected from the group comprising L-glufosinate sodium, L-glufosinate potassium, L-glufosinate ammonium, or combinations thereof. The inorganic salts of L-glufosinate can be selected from the group comprising monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, —NH₂(CH₃)(C₂H₄OH)⁺ salt, or combinations thereof.

In an embodiment, the L-glufosinate salt is L-glufosinate ammonium.

In an embodiment, the L-glufosinate salt is L-glufosinate sodium.

In an embodiment, the L-glufosinate salt is L-glufosinate potassium.

In another embodiment, the present disclosure provides a herbicidal combination comprising L-glufosinate ammonium and at least one additional herbicide.

In another embodiment, the present disclosure provides a synergistic herbicidal combination comprising L-glufosinate ammonium and at least one additional herbicide.

In another embodiment, the present disclosure provides a synergistic herbicidal combination for controlling Brachiaria genus weeds, wherein the combination comprises L-glufosinate ammonium and at least one additional herbicide selected from the group comprising:
(a) protoporphyrinogen oxidase inhibitor herbicides;
(b) auxin herbicides;
or combinations thereof.

In an embodiment, the protoporphyrinogen oxidase inhibitor herbicide is selected from one or more herbicides, or their salts, esters, isomers and combinations thereof.

TABLE A
Protoporphyrinogen oxidase inhibitor herbicide

| | | Protoporphyrinogen |
|---|---|---|
| Sr. | Chemical class of Protoporphyrinogen | oxidase inhibitor |
| No. | Oxidase inhibitor herbicides | herbicides |
| 1. | Diphenyl ethers | Acifluorfen |
| 2. | | Bifenox |
| 3. | | Chlomethoxyfen |
| 4. | | Chlornitrofen |
| 5. | | Fluorodifen |
| 6. | | Fluoroglycofen-ethyl |
| 7. | | Fluoronitrofen |
| 8. | | Fomesafen |
| 9. | | Lactofen |
| 10. | | Nitrofen |
| 11. | | Oxyfluorfen |
| 12. | N-Phenyl-imides | Butafenacil |
| 13. | | Chlorphthalim |
| 14. | | Cinidon-ethyl |
| 15. | | Epyrifenacil |
| 16. | | Flumiclorac-pentyl |
| 17. | | Flumioxazin |
| 18. | | Flumipropyn |
| 19. | | Pentoxazone |
| 20. | | Saflufenacil |
| 21. | | Tiafenacil |
| 22. | | Trifludimoxazin |
| 23. | | Fluthiacet-methyl |
| 24. | N-Phenyl-oxadiazolones | Oxadiargyl |
| 25. | | Oxadiazon |
| 26. | N-Phenyl-triazolinones | Azafenidin |
| 27. | | Carfentrazone-ethyl |
| 28. | | Sulfentrazone |
| 29. | Other | Pyraclonil |
| 30. | Phenylpyrazoles | Pyraflufen-ethyl |

In an embodiment, the auxin herbicide is selected from one or more herbicides, or their salts, esters, isomers and combinations thereof.

TABLE B
Auxin herbicides

| Sr. | | |
|---|---|---|
| No. | Chemical Class of Auxin herbicides | Auxin herbicides |
| 1. | Benzoates | Chloramben |
| 2. | | Dicamba |
| 3. | | Terbuthylazine (TBA) |
| 4. | Phenoxy-carboxylates | 2,4,5- |
| | | Trichlorophenoxyacetic |
| | | acid (2,4,5-T) |
| 5. | | 2,4- |
| | | dichlorophenoxyacetic |
| | | acid (2,4-D) choline |
| 6. | | 4-(2,4- |
| | | dichlorophenoxy)butyric |
| | | acid (2,4-DB) |
| 7. | | Clomeprop |
| 8. | | Dichlorprop |
| 9. | | Fenoprop |
| 10. | | 2-methyl-4- |
| | | chlorophenoxyacetic acid |
| | | (MCPA) |
| 11. | | 4-(4-chloro-o- |
| | | tolyloxy)butyric acid |
| | | (MCPB) |
| 12. | | Mecoprop |
| 13. | Phenyl carboxylates | Chlorfenac |
| 14. | | Chlorfenprop |
| 15. | Pyridine-carboxylates | Aminopyralid |
| 16. | | Clopyralid |
| 17. | | Florpyrauxifen |
| 18. | | Halauxifen |
| 19. | | Picloram |
| 20. | Pyridyloxy-carboxylates | Fluroxypyr |
| 21. | | Triclopyr |
| 22. | Pyrimidine-carboxylates | Aminocyclopyrachlor |
| 23. | Quinoline-carboxylates | Quinmerac |
| 24. | Other | Benazolin-ethyl |

In an embodiment, the present disclosure provides a method for controlling weeds by applying a synergistic herbicidal combination comprising L-glufosinate, salts, esters, or combinations thereof and at least one additional herbicide, wherein the additional herbicide comprises:
(a) the protoporphyrinogen oxidase inhibitor herbicide comprising saflufenacil; and
(b) the auxin herbicide selected from the group comprising 2,4-D, triclopyr, 2,4-D choline, or combinations thereof.

In an embodiment, the present disclosure provides a synergistic herbicidal combination comprising L-glufosinate, salts, esters, or combinations thereof and at least one protoporphyrinogen oxidase inhibitor herbicide for controlling Brachiaria genus weeds.

In an embodiment, the present disclosure provides a synergistic herbicidal combination comprising L-glufosinate ammonium and at least one protoporphyrinogen oxidase inhibitor herbicide for controlling Brachiaria genus weeds.

In a preferred embodiment, the protoporphyrinogen oxidase inhibitor herbicide is saflufenacil.

In an embodiment, the present disclosure provides a synergistic herbicidal combination comprising L-glufosinate and saflufenacil for controlling Brachiaria genus weeds.

In an embodiment, the present disclosure provides a synergistic herbicidal combination comprising L-glufosinate ammonium and saflufenacil for controlling Brachiaria genus weeds.

In an embodiment, the present disclosure provides a synergistic herbicidal combination comprising L-glufosinate, salts, esters, or combinations thereof and at least one auxin herbicide for controlling Brachiaria genus weeds.

In an embodiment, the present disclosure provides a synergistic herbicidal combination comprising L-glufosinate ammonium and at least one auxin herbicide for controlling Brachiaria genus weeds.

In an embodiment, the auxin herbicide is 2,4-D.

In an embodiment, the present invention provides a synergistic herbicidal combination comprising L-glufosinate and 2,4-D for controlling Brachiaria genus weeds.

In an embodiment, the present disclosure provides a synergistic herbicidal combination comprising L-glufosinate ammonium and 2,4-D for controlling Brachiaria genus weeds.

In an embodiment, the auxin herbicide is 2,4-D choline.

In an embodiment, the present invention provides a synergistic herbicidal combination comprising L-glufosinate and 2,4-D choline for controlling Brachiaria genus weeds.

In an embodiment, the present disclosure provides a synergistic herbicidal combination comprising L-glufosinate ammonium and 2,4-D choline for controlling Brachiaria genus weeds.

In an embodiment, the auxin herbicide is triclopyr.

In an embodiment, the present invention provides a synergistic herbicidal combination comprising L-glufosinate and triclopyr for controlling Brachiaria genus weeds.

In an embodiment, the present disclosure provides a synergistic herbicidal combination comprising L-glufosinate ammonium and triclopyr for controlling Brachiaria genus weeds.

In an embodiment, the present disclosure provides a synergistic herbicidal combination comprising L-glufosinate, salts, esters, or combinations thereof and at least two additional herbicides for controlling Brachiaria genus weeds.

In an embodiment, the present disclosure provides a synergistic herbicidal combination comprising L-glufosinate, salts, esters, or combinations thereof, a protoporphyrinogen oxidase inhibitor herbicide and an auxin herbicide for controlling Brachiaria genus weeds.

In an embodiment, the present disclosure provides a synergistic herbicidal combination comprising L-glufosinate, salts, esters, or combinations thereof, saflufenacil and triclopyr for controlling Brachiaria genus weeds.

In an embodiment, the present disclosure provides a synergistic herbicidal combination comprising L-glufosinate ammonium, saflufenacil and triclopyr for controlling Brachiaria genus weeds.

In an embodiment, the present disclosure provides a method of controlling Brachiaria genus weeds at a locus thereof, by applying a herbicidal combination comprising L-glufosinate, salts, esters, or combinations thereof and at least one additional herbicide, wherein a weight ratio of L-glufosinate, salts, esters, or combinations thereof and at least one additional herbicide ranges from about 1:100 to about 100:1.

In a preferred embodiment, the weight ratio of L-glufosinate, salts, esters, or combinations thereof and at least one additional herbicide is selected from ratios comprising 1:1, 1:10, 1:20, 1:30, 1:40, 1:50, 1:60, 1:70, 1:80, 1:90 and 1:100.

In a preferred embodiment, the weight ratio of L-glufosinate, salts, esters, or combinations thereof and at least one additional herbicide is selected from ratios comprising 1:1, 10:1, 20:1, 30:1, 40:1, 50:1, 60:1, 70:1, 80:1, 90:1 and 100:1.

In an embodiment, the weight ratio of L-glufosinate, salts, esters, or combinations thereof and at least one protoporphyrinogen oxidase inhibitor herbicide is in the range from about 1:100 to about 100:1.

In an embodiment, the weight ratio of L-glufosinate, salts, esters, or combinations thereof and at least one auxin herbicide is in the range from about 1:100 to about 100:1.

In another embodiment, the weight ratio of L-glufosinate, salts, esters, or combinations thereof and the additional herbicide ranges from about 1:75 to about 75:1.

In still another embodiment, the weight ratio of L-glufosinate, salts, esters, or combinations thereof and the additional herbicide is in the range from about 1:50 to about 50:1.

In still another embodiment, the weight ratio of L-glufosinate, salts, esters, or combinations thereof and the additional herbicide is in the range from about 1:25 to about 25:1.

In still another embodiment, the weight ratio of L-glufosinate, salts, esters, or combinations thereof and the additional herbicide is in the range from about 1:10 to about 10:1.

In a preferred embodiment, the weight ratio of L-glufosinate, salts, esters, or combinations thereof and the additional herbicide is in the range from about 1:5 to about 5:1.

In an embodiment, the weight ratio of L-glufosinate, salts, esters, or combinations thereof and at least one protoporphyrinogen oxidase inhibitor herbicide is in the range from about 1:5 to about 5:1.

In an embodiment, the weight ratio of L-glufosinate, salts, esters, or combinations thereof and at least one auxin herbicide is in the range from about 1:5 to about 5:1.

In a preferred embodiment, the weight ratio of L-glufosinate ammonium and saflufenacil is about 1:3.

In a preferred embodiment, the weight ratio of L-glufosinate ammonium and saflufenacil is about 1:2.5.

In an embodiment, the weight ratio of L-glufosinate, salts, esters, or combinations thereof and at least two additional herbicide ranges from about 1:100:100 to about 100:1:1.

In an embodiment, the weight ratio of L-glufosinate, salts, esters, or combinations thereof and at least two additional herbicide ranges from about 1:25:25 to about 25:1:1.

In an embodiment, the weight ratio of L-glufosinate, salts, esters, or combinations thereof and at least two additional herbicide ranges from about 1:10:10 to about 10:1:1.

In an embodiment, the weight ratio of L-glufosinate, salts, esters, or combinations thereof and at least two additional herbicide ranges from about 1:5:5 to about 5:1:1.

In an embodiment, the weight ratio of L-glufosinate, salts, esters, or combinations thereof and at least one protoporphyrinogen oxidase inhibitor herbicide and at least one auxin herbicide ranges from about 1:0.1:0.1 to about 1:25:25.

In an embodiment, the weight ratio of L-glufosinate, salts, esters, or combinations thereof and at least one protoporphyrinogen oxidase inhibitor herbicide and at least one auxin herbicide ranges from about 1:0.1:0.1 to about 1:10:10.

In an embodiment, the weight ratio of L-glufosinate, salts, esters, or combinations thereof and at least one protoporphyrinogen oxidase inhibitor herbicide and at least one auxin herbicide ranges from about 1:0.1:0.1 to about 1:5:5.

In a preferred embodiment, the weight ratio of L-glufosinate ammonium, saflufenacil and triclopyr is about 1:3:2.

In a preferred embodiment, the weight ratio of L-glufosinate ammonium, saflufenacil and triclopyr is about 1:2.5:1.62.

In a preferred embodiment, the weight ratio of L-glufosinate ammonium, saflufenacil and 2,4-D is about 1:3:2.

In a preferred embodiment, the weight ratio of L-glufosinate ammonium, saflufenacil and 2,4-D is about 1:2.5:1.71.

In an embodiment, at least one additional herbicide which can be combined with L-glufosinate, salts, esters, or combinations thereof is selected from the group comprising:
(a) protoporphyrinogen oxidase inhibitor herbicides;
(b) auxin herbicides;
or combinations thereof.

In another aspect, there is provided use of a synergistic herbicidal combination for controlling Brachiaria genus weeds.

In another aspect, there is provided use of a synergistic herbicidal combination comprising L-glufosinate, salts, esters, or combinations thereof and at least one additional herbicide, for controlling Brachiaria genus weeds.

In another aspect, there is provided use of a synergistic herbicidal combination comprising L-glufosinate ammonium and at least one additional herbicide, for controlling Brachiaria genus weeds.

In another aspect, there is provided use of a synergistic herbicidal combination for controlling Brachiaria genus weeds, wherein said combination comprises:
(a) L-glufosinate, salts, esters, or combinations thereof; and
(b) at least one additional herbicide selected from the group comprising protoporphyrinogen oxidase inhibitor herbicides, auxin herbicides, or combinations thereof.

In another aspect, there is provided use of a synergistic herbicidal combination for controlling Brachiaria genus weeds, wherein said combination comprises:
(a) L-glufosinate ammonium; and
(b) at least one additional herbicide selected from the group comprising protoporphyrinogen oxidase inhibitor herbicides, auxin herbicides, or combinations thereof.

The herbicidal combinations of the present disclosure can be used in agricultural lands such as fields, paddy fields, lawns, and orchards or in non-agricultural lands. The present disclosure may be used to control diseases in agricultural lands for cultivating the plants without any phytotoxicity to the plant.

In an embodiment, the present disclosure provides a method for controlling weeds by applying a herbicidal combination comprising:
(a) L-glufosinate, salts, esters, or combinations thereof; and
(b) at least one additional herbicide selected from the group comprising protoporphyrinogen oxidase inhibitor herbicides, auxin herbicides, or combinations thereof;
wherein the weeds comprise Brachiaria genus weeds.

In another aspect the present invention provides a method of controlling Brachiaria genus weeds at a locus, the method comprising applying a synergistic herbicidal combination comprising L-glufosinate, salts, esters, or combinations thereof and at least one additional herbicide selected from the group comprising:
(a) protoporphyrinogen oxidase inhibitor herbicides;
(b) auxin herbicides;
or combinations thereof.

In an embodiment the method comprises application of present herbicidal combinations to a locus of a plant, wherein Brachiaria genus weeds occur or are expected to occur.

In an embodiment, the method of controlling Brachiaria genus weeds comprises applying at a locus thereof, a synergistic herbicidal combination comprising L-glufosinate, salts, esters, or combinations thereof and at least one additional herbicide, wherein L-glufosinate, salts, esters, or combinations thereof is applied at an application rate of about 1 g a.i./ha to about 3000 g a.i./ha.

In an embodiment, L-glufosinate, salts, esters, or combinations thereof is applied at an application rate of about 1 g a.i./ha to about 2000 g a.i./ha.

In an embodiment, L-glufosinate, salts, esters, or combinations thereof is applied at an application rate of about 50 g a.i./ha to about 1000 g a.i./ha.

In an embodiment, L-glufosinate, salts, esters, or combinations thereof is applied at an application rate of about 50 g a.i./ha to about 500 g a.i./ha.

In an embodiment, L-glufosinate, salts, esters, or combinations thereof is applied at an application rate of about 50 g a.i./ha to about 350 g a.i./ha.

In a preferred embodiment, L-glufosinate ammonium in the herbicidal combination is applied at an application rate of about 300 g a.i./ha.

In a preferred embodiment, L-glufosinate ammonium in the herbicidal combination is applied at an application rate of about 250 g a.i./ha.

In a preferred embodiment, L-glufosinate ammonium in the herbicidal combination is applied at an application rate of about 150 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the group comprising:
(a) the protoporphyrinogen oxidase inhibitor herbicide applied at an application rate from about 1 g a.i./ha to about 200 g a.i./ha; and
(b) the auxin herbicide applied at an application rate from about 100 g a.i./ha to about 500 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from protoporphyrinogen oxidase inhibitor herbicides, wherein the protoporphyrinogen oxidase inhibitor herbicide is applied at an application rate of about 1 g a.i./ha to about 250 g a.i./ha.

In an embodiment, the protoporphyrinogen oxidase inhibitor herbicide is applied at an application rate of about 1 g a.i./ha to about 200 g a.i./ha.

In an embodiment, the protoporphyrinogen oxidase inhibitor herbicide is applied at an application rate of about 1 g a.i./ha to about 150 g a.i./ha.

In an embodiment, the protoporphyrinogen oxidase inhibitor herbicide is applied at an application rate of about 1 g a.i./ha to about 100 g a.i./ha.

In a preferred embodiment, saflufenacil in the herbicidal combination is applied at an application rate of about 30 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from auxin herbicides, wherein the auxin herbicide is applied at an application rate of about 1 g a.i./ha to about 500 g a.i./ha.

In an embodiment, the auxin herbicide is applied at an application rate of about 100 g a.i./ha to about 500 g a.i./ha.

In an embodiment, the auxin herbicide is applied at an application rate of about 100 g a.i./ha to about 400 g a.i./ha.

In an embodiment, the auxin herbicide is applied at an application rate of about 100 g a.i./ha to about 300 g a.i./ha.

In a preferred embodiment, triclopyr in the herbicidal combination is applied at an application rate of about 228 g a.i./ha.

In a preferred embodiment, 2,4-D in the herbicidal combination is applied at an application rate of about 228 g a.i./ha.

In an embodiment, the compositions and methods disclosed herein can be used to control undesired vegetation in a variety of crop and non-crop applications. In some embodiments, the compositions and methods disclosed herein can be used for controlling undesired vegetation in crops.

Examples of the crops on which the combinations according to the present disclosure may be used include, but are not limited to, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., Asteraceae vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In a preferred embodiment, the Brachiaria genus weed is Brachiaria decumbens.

In another aspect, there is provided a synergistic herbicidal composition for controlling Brachiaria genus weeds.

In another aspect, there is provided a synergistic herbicidal composition comprising L-glufosinate, salts, esters, or combinations thereof and at least one additional herbicide, for controlling Brachiaria genus weeds.

In another aspect, there is provided a synergistic herbicidal composition comprising L-glufosinate ammonium and at least one additional herbicide, for controlling Brachiaria genus weeds.

In another embodiment, the present disclosure provides a herbicidal composition for controlling Brachiaria genus weeds, said composition comprising:
(a) L-glufosinate, salts, esters, or combinations thereof; and
(b) at least one additional herbicide selected from the group comprising protoporphyrinogen oxidase inhibitor herbicides, auxin herbicides, or combinations thereof.

In another embodiment, the present disclosure provides a herbicidal composition for controlling Brachiaria genus weeds, said composition comprising:
(a) L-glufosinate ammonium; and
(b) at least one additional herbicide selected from the group comprising protoporphyrinogen oxidase inhibitor herbicides, auxin herbicides, or combinations thereof.

In one embodiment, in combinations and compositions of the present disclosure, L-glufosinate, salts, esters, or combinations thereof is present in an amount from about 100 g a.i./L to about 1000 g a.i./L.

In an embodiment, in combinations and compositions of the present disclosure, L-glufosinate, salts, esters, or combinations thereof is present in an amount from about 100 g a.i./L to about 500 g a.i./L.

In an embodiment, in combinations and compositions of the present disclosure, L-glufosinate, salts, esters, or combinations thereof is present in an amount from about 100 g a.i./L to about 400 g a.i./L.

In one embodiment, in combinations and compositions of the present disclosure, L-glufosinate, salts, esters, or combinations thereof is present in an amount from about 180 g a.i./L to about 380 g a.i./L.

In one embodiment, in combinations and compositions of the present disclosure, L-glufosinate, salts, esters, or combinations thereof is present in an amount from about 250 g a.i./L to about 300 g a.i./L.

In an embodiment, in combinations of the present disclosure, L-glufosinate, salts, esters, or combinations thereof is present in an amount of about 280 g a.i./L.

In an embodiment, in combinations of the present disclosure, L-glufosinate ammonium is present in an amount of about 280 g a.i./L.

In an embodiment, in combinations of the present disclosure, L-glufosinate ammonium is present in an amount of about 200 g a.i./L.

In an embodiment, in combinations of the present disclosure, L-glufosinate ammonium is present in an amount of about 150 g a.i./L.

In another embodiment, the present disclosure provides a herbicidal composition comprising a synergistic combination comprising L-glufosinate, salts, esters, or combinations thereof and at least one additional herbicide selected from the protoporphyrinogen oxidase inhibitor herbicides, wherein the protoporphyrinogen oxidase inhibitor herbicide is present in an amount in the range from about 1 g a.i./L to about 1000 g a.i./L.

In an embodiment, the protoporphyrinogen oxidase inhibitor herbicide is present in an amount in the range from about 100 g a.i./L to about 1000 g a.i./L.

In an embodiment, the amount of protoporphyrinogen oxidase inhibitor herbicide used in the combination, composition or methods of the present disclosure is in the range from about 200 g a.i./L to about 900 g a.i./L.

In an embodiment, the amount of protoporphyrinogen oxidase inhibitor herbicide used in the combination, composition or methods of the present disclosure is in the range from about 300 g a.i./L to about 1000 g a.i./L.

In a preferred embodiment, the amount of saflufenacil present in the combination, composition or methods of the present disclosure is about 700 g a.i./L.

In another embodiment, the present disclosure provides a herbicidal composition comprising a synergistic combination comprising L-glufosinate, salts, esters, or combinations thereof and at least one additional herbicide selected from auxin herbicides, wherein the auxin herbicide is present in an amount in the range from about 1 g a.i./L to about 1000 g a.i./L.

In an embodiment, the auxin herbicide is present in an amount in the range from about 100 g a.i./L to about 1000 g a.i./L.

In an embodiment, the amount of auxin herbicide used in the combination, composition or methods of the present disclosure is in the range from about 100 g a.i./L to about 800 g a.i./L.

In an embodiment, the amount of auxin herbicide used in the combination, composition or methods of the present disclosure is in the range from about 100 g a.i./L to about 700 g a.i./L.

In a preferred embodiment, the amount of triclopyr present in the combination, composition or methods of the present disclosure is about 456 g a.i./L.

In a preferred embodiment, the amount of 2,4-D present in the combination, composition or methods of the present disclosure is about 480 g a.i./L.

In a preferred embodiment, the Brachiaria genus weed is Brachiaria decumbens.

In an embodiment, the herbicidal combination is applied jointly, or separately, or sequentially, or simultaneously to a plant or a locus thereof to control from about 80% to about 100% of the weeds.

In an embodiment, the present invention provides L-glufosinate, salts, esters, or combinations thereof in combination with at least one additional herbicide, wherein the combination controls from about 80% to about 100% of the weeds.

In an embodiment, the present invention provides the use of L-glufosinate, salts, esters, or combinations thereof applied at a rate of about 150 g a.i./ha, in combination with at least one additional herbicide applied in a range from about 1 g a.i./ha to about 500 g a.i./ha, wherein the combination controls from about 80% to about 100% of the weeds.

In an embodiment, the present invention provides the use of L-glufosinate, salts, esters, or combinations thereof applied at a rate of about 150 g a.i./ha, in combination with Saflufenacil applied at a rate of about 30 g a.i./ha for controlling Brachiaria decumbens, wherein the combination controls from about 85% to about 100% of the weed at or within 3, 7, 14, 21, 28 to 35 days after application (DAA).

In an embodiment, the present invention provides the use of L-glufosinate, salts, esters, or combinations thereof applied at a rate of about 150 g a.i./ha, in combination with Saflufenacil applied at a rate of about 30 g a.i./ha and triclopyr applied at a rate of about 228 g a.i./ha for controlling Brachiaria decumbens, wherein the combination controls from about 80% to about 85% of the weed at or within 3, 7, 14, 21, 28 to 35 days after application (DAA).

In an embodiment, the present invention provides the use of L-glufosinate, salts, esters, or combinations thereof applied at a rate of about 150 g a.i./ha, in combination with Saflufenacil applied at a rate of about 30 g a.i./ha and 2,4-D applied at a rate of about 228 g a.i./ha for controlling Brachiaria decumbens, wherein the combination controls from about 80% to about 85% of the weed at or within 3, 7, 14, 21, 28 to 35 days after application (DAA).

In an embodiment, the herbicidal compositions according to the present disclosure for controlling Brachiaria genus weeds, comprises at least one agrochemically suitable excipients/additive in addition to herbicidal combination comprising L-glufosinate, salts, esters, or combinations thereof and at least one additional herbicide.

In an embodiment, the present disclosure provides a herbicidal composition for controlling Brachiaria decumbens, said composition comprising:
(a) L-glufosinate, salts, esters, or combinations thereof; and
(b) at least one additional herbicide selected from the group comprising protoporphyrinogen oxidase inhibitor herbicides, auxin herbicides, or combinations thereof; and
(c) at least one agrochemically acceptable excipient.

In an embodiment, the present disclosure provides a herbicidal composition for controlling Brachiaria decumbens, said composition comprising:
(a) L-glufosinate ammonium; and
(b) at least one additional herbicide selected from the group comprising protoporphyrinogen oxidase inhibitor herbicides, auxin herbicides, or combinations thereof; and
(c) at least one agrochemically acceptable excipient.

In a preferred embodiment, Brachiaria genus weeds is Brachiaria decumbens.

In an embodiment, the present combinations/compositions can further contain one or more co-herbicides.

The examples of co-herbicides that can be combined with present herbicidal combinations include, but are not limited to, tetflupyrolimet, dioxopyritrione, rimisoxafen, benquitrione, bipyrazone, cypyrafluone, fenpyrazone, tripyrasulfone, anisiflupurin, beflubutamid, bixlozone, cyclopyranil, dimesulfazet, epyrifenacil, topramezone, orthosulfamuron, pinoxaden, metamifop, pyrimisulfan, tembotrione, thiencarbazone methyl, flucetosulfuron, aminopyralid, pyrasulfotole, saflufenacil, pyroxsulam, pyroxasulfone, pyraclonil, indaziflam, fenquinotrione, florpyrauxifen-benzyl, tiafenacil, cinmethylin, lancotrione-sodium, bixlozone, trifludimoxazin, cyclopyrimorate, methiozolin, aminocyclopyrachlor, metazosulfuron, ipfencarbazone, fenoxasulfone, bicyclopyrone, triafamone, halauxifen methyl and tolpyralate.

In an embodiment, the agrochemically acceptable excipients/carriers/additives comprise at least one co-solvent(s), surfactant(s), water, colorant(s), dispersant(s), emulsifier(s), thickener(s), antifreeze agent(s), biocide(s), anti-foam agent(s), stabilizer(s), wetting agent(s), or combinations thereof.

In an embodiment, the surfactant(s) may be selected from non-ionic, anionic, cationic surfactants, or combinations thereof.

In an embodiment, the examples of non-ionic surfactants comprise polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol, or combinations thereof.

In an embodiment, the examples of anionic surfactants comprise alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates, or combinations thereof.

In an embodiment, the cationic surfactants comprise alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates, or combinations thereof.

In an embodiment, the emulsifier(s) which can be advantageously employed herein can be readily determined by those skilled in the art and comprise various non-ionic, anionic, cationic and amphoteric emulsifiers, or a blend of two or more emulsifiers. Examples of nonionic emulsifiers useful in preparing emulsifiable concentrates, for example, include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether, or combinations thereof.

In an embodiment, the colorant(s) comprise iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum, zinc, or combinations thereof.

Another embodiment involves addition of a thickener or binder which may be selected from the group comprising molasses, granulated sugar, alginates, karaya gum, jaguar gum, tragacanth gum, polysaccharide gum, mucilage, xanthan gum, or combinations thereof. In another embodiment, the binder may be selected from the group comprising silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols, or combinations thereof.

In another embodiment, an antifreeze agent(s) added to the composition may be alcohols selected from the group comprising ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol, or combinations thereof.

According to an embodiment, the biocide(s) or preservative(s) comprise benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl, or combinations thereof.

According to the antifoam agent(s) comprise an embodiment, polydimethoxysiloxane, polydimethylsiloxane, alkyl poly acrylates, castor oil, fatty acids, fatty acid esters, fatty acid sulfates, fatty alcohols, fatty alcohol esters, fatty alcohol sulfates, olive oil, mono and di glycerides, paraffin oil, paraffin wax, polypropylene glycol, silicone oil, vegetable and animal fats, sulfates of vegetable and animal fat, vegetable and animal oils, sulfates of vegetable and animal oils, vegetable and animal waxes, sulfates of vegetable and animal waxes, agents based on silicon or magnesium stearate, or combinations thereof.

According to an embodiment, the agrochemical formulation may also comprise one or more antioxidants. Preferably, the agrochemical formulation comprises an antioxidant. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA (Ethylenediaminetetraacetic acid), EGTA (Ethylenebis(oxyethylenenitrilo)tetraacetic acid), phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to an embodiment, the mixtures of the aforementioned antioxidants are possible.

According to an embodiment, the examples of solvents are water, aromatic solvents (for example xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones, N-Methyl-2 -pyrrolidone (NMP), N-Ethyl-2 pyrrolidone (NEP), N-Octyl-2-pyrrolidone (NOP), acetates (glycol diacetate), glycols, fatty acid dimethylamides, fatty acids and fatty acid esters, isophorone and dimethylsulfoxide, or combinations thereof.

According to an embodiment, solvent mixtures may also be used.

According to an embodiment, exemplary surfactants comprise alkali metal, alkaline earth metal and ammonium salts of lignosulfonic acid, naphthalene sulfonates, phenolsulfonic acid, dibutylnaphthalenesulfonic acid, alkylarylsulfonates, alkyl sulfates, alkyl sulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalene sulfonic acid with phenol and formaldehyde, polyoxyethylene octyl phenol ethers, ethoxylated isooctylphenol, octyl phenol, nonylphenol, alkylphenol polyglycol ethers, tributyl phenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose, or combinations thereof.

According to an embodiment, examples of carriers comprise mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, urea, and products of vegetable origin, such as cereal meal, tree bark meal, wood meal and nutshell meal, cellulose powders, polyvinylpyrrolidone and other solid carriers, or combinations thereof.

In another aspect, present compositions may further comprise at least safener.

In an embodiment the safener can be selected from the group comprising isoxadifen-ethyl, cloquintocet-mexyl, mefenpyr-diethyl, naphthalic anhydride, oxabetrinil, benzenesulfonamide, N-(aminocarbonyl)-2-chlorobenzene sulfonamide (2-CBSU), daimuron, dichloroacetamide, dicyclonon, fenchlorazole-ethyl, fenclorim, fluxofenim, Dichloroacetamide safeners (e.g., AD-67, benoxacor, dichlormid, and furilazole), naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl, 1-dichloroacetylhexahydro-3,3,8α-trimethylpyrrolo[1,2-α]pyrimidin-6-(2H-one), dichloromethyl-1,3-dioxolane, quinolinyloxyacetate compounds, or agriculturally acceptable salts, esters, or combinations thereof.

In an embodiment, the composition may be present in any agrochemically suitable form for storage and application to the ground. The compositions may be produced by mixing the actives in the composition with an inert carrier and adding surfactants and other adjuvants and carriers as needed and formulated into solid or liquid formulations, comprising wettable powders (WP), granules (GR), dusts, soluble (liquid) concentrates (SL), suspension concentrates (SC), oil in water emulsion (EW), water in oil emulsion (EO), emulsifiable concentrates (EC), capsule suspensions (CS), mixed formulation of CS and SC (ZC) formulations, oil dispersions (OD), other known formulation types, or combinations thereof. The composition may also be used for treatment of a plant propagation material, such as seeds, etc.

The herbicidal combinations and compositions of the present disclosure can be in any conventional agriculturally useful form, for example, in a form of a ready-to-use formulation (premix or ready-mix), or in a form of a tank mix.

In an embodiment, compositions/combinations of the present disclosure may be applied either pre-emergence or post-emergence. Advantageously, the compositions/combinations of the present disclosure provide significant and improved control of weeds, when applied in post-emergence stage.

In an embodiment, the method for controlling target weeds comprises applying the premix formulation or tank-mix formulation comprising L-glufosinate, salts, esters, or combinations thereof and at least one additional herbicide, at the desired locus.

In an embodiment, the method for controlling target weeds comprises applying the premix formulation or tank-mix formulation comprising L-glufosinate ammonium and at least one additional herbicide, at the desired locus.

In an embodiment, the combination or tank-mix formulation comprising L-glufosinate, salts, esters, or combinations thereof and at least one additional herbicide further comprises at least one co-herbicide.

In an embodiment, each individual composition may further comprise one or more agrochemically acceptable excipient/ingredients. The resulting combination or tank-mix formulation of the composition comprising L-glufosinate, salts, esters, or combinations thereof, at least one additional herbicide, and at least one co-herbicide provides a synergistic effect in controlling Brachiaria genus weeds.

In an embodiment, the herbicides of the combinations of the present disclosure maybe applied simultaneously as a tank mix or in a formulation or may be applied sequentially. The sequential application may be in immediate succession or with a time gap and may be carried in any order as deemed to be effective by the person skilled in the art. The application may be made to the soil before emergence of the plants, either pre-planting or post-planting. The application may be made to the soil after emergence of the plants. The application may be made as a foliar spray at different timings during crop development, with either one or more applications early or late post-emergence. Herbicidal compositions according to the disclosure can also be incorporated into the soil before, during or after sowing seeds of a crop.

These combinations as described above may be applied to the locus of the weeds, in an herbicidally effective amount.

In an embodiment, the combinations or the compositions comprising L-glufosinate or L-glufosinate salts according to the present disclosure may be used for burndown application or fallow application.

In an embodiment, the method comprises applying composition comprising L-glufosinate, salts, esters, or combinations thereof and at least one additional herbicide as a tank mix.

In an embodiment, the method comprises applying tank mix composition comprising L-glufosinate, salts, esters, or combinations thereof and at least one additional herbicide selected from the group comprising:
(a) protoporphyrinogen oxidase inhibitor herbicides;
(b) auxin herbicides;
or combinations thereof.

In an embodiment, the method comprises applying composition comprising L-glufosinate, salts, esters, or combinations thereof and at least one additional herbicide as a premix.

In an embodiment, the method comprises applying the present combinations or compositions simultaneously, that is jointly or separately, or in succession.

In an embodiment, the method comprises applying in immediate succession the combination comprising L-glufosinate, salts, esters, or combinations thereof and at least one additional herbicide.

The compositions of the present disclosure may be applied in any known ways or conventional methods known to a person skilled in art. Non limiting examples of such methods are foliar spray, basal barking, stem injection, drill and fill method, axe cut method, cut stump, cut and swab, stem scraper, wick application and so forth. The compositions of the present disclosure are used in the customary manner, for example by watering, spraying, atomizing, dusting, or scattering. Said compositions can be applied to a locus using conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

In some embodiments, wherein the undesirable and harmful vegetation is treated post-emergence, the compositions disclosed herein are applied by foliar application. In accordance with present disclosure the method of control of target weeds may be carried out by spraying the suggested tank mixes, or the individual herbicides may be formulated as a kit-of-parts containing various components that may be mixed as instructed prior to spraying.

In an embodiment, the present disclosure provides a kit-of-parts comprising L-glufosinate, salts, esters, or combinations thereof and another component of an additional herbicide or herbicides. The kit-of-parts may additionally comprise a component comprising one or more agrochemically acceptable ingredients. The kit-of-parts may additionally be accompanied with a set of instructions for mixing or use of the components provided therein.

According to an embodiment, the kit of parts comprises:
(a) L-glufosinate, salts, esters, or combinations thereof;
(b) at least one additional herbicide selected from the group comprising protoporphyrinogen oxidase inhibitor herbicides, auxin herbicides, or combinations thereof; and
(c) at least one agrochemically acceptable excipient;
and optionally further comprises:
(d) instructions for use.

According to an embodiment, the kit of parts comprises:
(a) L-glufosinate ammonium;
(b) at least one additional herbicide selected from the group comprising protoporphyrinogen oxidase inhibitor herbicides, auxin herbicides, or combinations thereof; and
(c) at least one agrochemically acceptable excipient;
and optionally further comprises:
(d) instructions for use.

In an embodiment, the present disclosure provides a method of increasing yield in a crop by application of a synergistic herbicidal combinations comprising L-glufosinate, salts, esters, or combinations thereof as described herein.

In an embodiment, the present disclosure provides a method of improving the plant health by application of a synergistic herbicidal combinations comprising L-glufosinate, salts, esters, or combinations thereof as described herein.

The herbicidal combinations/compositions of the present disclosure are highly safe to crop plants and capable of controlling target weeds problematic in e.g., paddy fields, upland fields, or non-agricultural fields over a wide range of from pre-emergency to post-emergence.

In view of the above, it will be seen that the several advantages of the disclosure are achieved, and other advantageous results are attained. Although the present disclosure has been disclosed in full, it will be understood that numerous additional modifications and variations could be made thereto without departing from the scope of the disclosure. The embodiments may be combined together for better understanding of the disclosure, without departing from the scope of the disclosure.

In another embodiment, alternative or multiple embodiments of the disclosure disclosed herein are not to be construed as limitations. Each embodiment can be referred to and claimed individually or in any combination with other embodiments of the disclosure. One or more embodiments of the disclosure can be combined together to exhibit the teaching of the invention, without departing from the scope of the disclosure.

The present disclosure is more particularly described in the following examples that are intended as illustration only, since numerous modifications and variations within the scope of the present disclosure will be apparent to those of skill in the art. The disclosure should therefore not be limited by the above-described embodiment, method, and following examples, but by all embodiments and methods within the scope and spirit of the disclosure.

The following examples illustrates the composition, underlying effect and basic methodology of the present disclosure.

### EXAMPLES

The following products were used for testing the weed control efficacy of present herbicidal combinations.

TABLE 1
Herbicides used in the present combinations

| | Dose | Formulation | Dose |
|---|---|---|---|
| Active ingredient | (g a.i./L) | Type | (g a.i./ha) |
| L-glufosinate | 280 | SL | 150 |
| ammonium | | | |
| Saflufenacil | 700 | WG | 30 |
| Triclopyr | 456 | EC | 228 |
| 2,4-D | 480 | SL | 228 |

### Evaluation of Post-Emergence Herbicidal Activity:

Methodology: Trials were carried out to evaluate the efficacy of the combination comprising L-glufosinate ammonium and additional herbicides on Brachiaria decumbens weed.

The soil used was sandy clay loam-sand: 68.0%; silt: 8.0%; clay: 24.0%.

All treatments were in 3 replications per treatment with a spray volume of about 150 L/ha.

### Efficacy Evaluation

The expected efficacy of a combination of L-glufosinate ammonium and the other herbicides was calculated using the well-established Colby method. Any difference between the observed and “expected” efficacy could be attributed to synergy between the two compounds.

In the Colby method, the expected (or predicted) response of a combination of herbicides is calculated by taking the product of the observed response for each individual component of the combination when applied alone, divided by 100, and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective (Colby, S. R., Weeds, 1967 (15), p. 20-22). The Colby method requires only a single dose of each herbicide applied alone and the mixture of both doses. The formula used to calculate the expected efficacy (EE) which was compared with the observed efficacy (OE) to determine the efficacy of the present disclosure is explained hereinbelow:

The expected efficacy for a combination of two active ingredients is as follows:

$$EE = ( A + B - ( A \times B ) / 100$$

The expected efficacy for a combination of three active ingredients is as follows:

$$EE = A + B + C - ( A B + A C + BC ) / 100 + ABC / 10 , 000$$

wherein,
A=Observed efficacy of active ingredient A at the same concentration as used in the mixture.
B=Observed efficacy of the active ingredient B at the same concentration as used in the mixture.
C=Observed efficacy of the active ingredient C at the same concentration as used in the mixture.

### Example 1: Efficacy of Combination L-Glufosinate Ammonium and Saflufenacil on Brachiaria decumbens

Experiment was conducted to assess the efficacy of the herbicidal combination comprising L-glufosinate ammonium and saflufenacil to control Brachiaria decumbens.

Table 2 demonstrates synergy in efficacy observed on the weed using the combination comprising L-glufosinate ammonium and saflufenacil. The percentage efficacy was calculated after 3, 7, 14, 21, 28 and 35 days of applications (DAA). The target weed was Brachiaria decumbens, and the results are recorded in Table 2.

TABLE 2
Efficacy observed on Brachiaria decumbens

| | | | | Observed |
|---|---|---|---|---|
| | Observed | | Expected | Efficacy (%) |
| | efficacy | | Efficacy* (%) of | of L- |
| Days | (%) of L- | Observed | L-glufosinate | glufosinate |
| after | glufosinate | efficacy (%) | ammonium + | ammonium + |
| appli- | ammonium | of | Saflufenacil | Saflufenacil |
| cation | (150 g | Saflufenacil | (150 + 30 g | (150 + 30 g |
| (DAA) | a.i./ha) | (30 g a.i./ha) | a.i./ha) | a.i./ha) |
| 3 | 65 | 30 | 75.5 | 85 |
| 7 | 75 | 30 | 82.5 | 88 |
| 14 | 75 | 25 | 81.25 | 100 |
| 21 | 70 | 10 | 73 | 100 |
| 28 | 60 | 0 | 60 | 100 |
| 35 | 55 | 0 | 55 | 100 |

*Expected efficacy according to Colby's Formula

Therefore, synergy was observed in the control of weed Brachiaria decumbens by application of herbicidal combination comprising L-glufosinate ammonium and Saflufenacil.

### Example 2: Efficacy of Combination L-Glufosinate Ammonium, Saflufenacil and Triclopyr on Brachiaria decumbens

Experiment was conducted to assess the efficacy of the herbicidal combination comprising L-glufosinate ammonium, saflufenacil and triclopyr to control the weed Brachiaria decumbens.

Table 3 demonstrates synergy in efficacy observed on the weed using the combination comprising L-glufosinate ammonium, saflufenacil and triclopyr. The percentage efficacy was calculated after 3, 7, 14, 21, 28 and 35 days of application (DAA). The target weed was Brachiaria decumbens, and the concentration of the herbicide and the results are recorded in Table 3.

TABLE 3
Efficacy observed on Brachiaria decumbens

| | | | | Expected | Observed |
|---|---|---|---|---|---|
| | | | | Efficacy* | Efficacy |
| | | | | (%) of L- | (%) of L- |
| | Observed | | | glufosinate | glufosinate |
| | efficacy | Observed | Observed | ammonium + | ammonium + |
| | (%) of L- | efficacy | efficacy | Saflufenacil + | Saflufenacil + |
| Days after | glufosinate | (%) of | (%) of | Triclopyr | Triclopyr |
| application | ammonium | Saflufenacil | Triclopyr | (150 + 30 + | (150 + 30 + |
| (DAA) | (150 g a.i./ha) | (30 g a.i./ha) | (228 g a.i./ha) | 228 g a.i./ha) | 228 g a.i./ha) |
| 3 | 65 | 30 | 0 | 75.5 | 80 |
| 7 | 75 | 30 | 0 | 82.5 | 85 |
| 14 | 75 | 20 | 20 | 84 | 88 |
| 21 | 70 | 5 | 10 | 74.35 | 85 |
| 28 | 65 | 0 | 5 | 66.75 | 85 |
| 35 | 60 | 0 | 0 | 60 | 85 |

*Expected efficacy according to Colby's Formula

Therefore, synergy was observed in the control of weed Brachiaria decumbens by application of herbicidal combination comprising L-glufosinate ammonium, Saflufenacil and Triclopyr.

### Example 3: Efficacy of Combination L-Glufosinate Ammonium, Saflufenacil and 2,4-D on Brachiaria decumbens

Experiment was conducted to assess the efficacy of the herbicidal combination comprising L-glufosinate ammonium, saflufenacil and 2,4-D to control the weed Brachiaria decumbens.

Table 4 demonstrates synergy in efficacy observed on the weed using the combination comprising L-glufosinate ammonium, saflufenacil and 2,4-D. The percentage efficacy was calculated after 3, 7, 14, 21, 28 and 35 days of application (DAA). The target weed was Brachiaria decumbens, and the concentration of the herbicide and the results are recorded in Table 4.

TABLE 4
Efficacy observed on Brachiaria decumbens

| | | | | Expected | Observed |
|---|---|---|---|---|---|
| | | | | Efficacy* | Efficacy |
| | | | | (%) of L- | (%) of L- |
| | | | | glufosinate | glufosinate |
| | Observed | | | ammonium + | ammonium + |
| | efficacy | Observed | Observed | Saflufenacil + | Saflufenacil + |
| | (%) of L- | efficacy | efficacy | 2,4-D | 2,4-D |
| Days after | glufosinate | (%) of | (%) of | (150 + 30 + | (150 + 30 + |
| application | ammonium | Saflufenacil | 2,4-D | 228 g | 228 g |
| (DAA) | (150 g a.i./ha) | (30 g a.i./ha) | (228 g a.i./ha) | a.i./ha) | a.i./ha) |
| 3 | 65 | 30 | 0 | 75.5 | 80 |
| 7 | 75 | 30 | 0 | 82.5 | 85 |
| 14 | 75 | 20 | 0 | 80 | 88 |
| 21 | 70 | 5 | 0 | 71.5 | 85 |
| 28 | 65 | 0 | 0 | 65 | 85 |
| 35 | 60 | 0 | 0 | 60 | 85 |

*Expected efficacy according to Colby's Formula

Therefore, synergy was observed in the control of weed Brachiaria decumbens by application of herbicidal combination comprising L-glufosinate ammonium, Saflufenacil and 2,4-D.

The results represented in above examples in Tables 2 to 4 clearly demonstrate synergy between L-glufosinate ammonium and additional herbicides. The large difference between the observed and the expected efficacy clearly demonstrates the synergistic effect of the present herbicidal combination.

1. A method for controlling weeds by applying a herbicidal combination comprising:
(a) L-glufosinate, salts, esters, or combinations thereof; and
(b) at least one additional herbicide selected from the group consisting of protoporphyrinogen oxidase inhibitor herbicides, auxin herbicides, and combinations thereof;
wherein the weeds comprise Brachiaria genus weeds.

2. The method as claimed in claim 1, wherein the salt comprises an inorganic salt of L-glufosinate.

3. The method as claimed in claim 2, wherein the inorganic salt of L-glufosinate is selected from the group consisting of L-glufosinate sodium, L-glufosinate potassium, L-glufosinate ammonium, and combinations thereof.

4. The method as claimed in claim 1, wherein
(a) the protoporphyrinogen oxidase inhibitor herbicide is saflufenacil; and
(b) the auxin herbicide is selected from the group consisting of 2,4-D, triclopyr, 2,4-D choline, and combinations thereof.

5. The method as claimed in claim 1, wherein a weight ratio of the L-glufosinate, salts, esters, or combinations thereof to at least one additional herbicide is in a range from about 1:25 to about 25:1.

6. The method as claimed in claim 1, wherein a weight ratio of the L-glufosinate, salts, esters, or combinations thereof to at least two additional herbicides is in a range from about 1:25:25 to about 25:1:1.

7. The method as claimed in claim 1, wherein the amount of the L-glufosinate, salts, esters, or combinations thereof is in a range from about 100 g a.i./L to about 400 g a.i./L.

8. The method as claimed in claim 1, wherein
(a) the protoporphyrinogen oxidase inhibitor herbicide is in a range from about 200 g a.i./L to about 900 g a.i./L; and
(b) the auxin herbicide is in a range from about 100 g a.i./L to about 700 g a.i./L.

9. The method as claimed in claim 1, wherein the L-glufosinate, salts, esters, or combinations thereof is applied at an application rate from about 50 g a.i./ha to about 350 g a.i./ha.

10. The method as claimed in claim 1, wherein
(a) the protoporphyrinogen oxidase inhibitor herbicide is applied at an application rate from about 1 g a.i./ha to about 200 g a.i./ha; and
(b) the auxin herbicide is applied at an application rate from about 100 g a.i./ha to about 500 g a.i./ha.

11. The method as claimed in claim 1, wherein the weed of Brachiaria genus is selected from the group comprising Brachiaria africana, Brachiaria coracona, Brachiaria floccifolia, Brachiaria decumbens, Brachiaria intermedia, Brachiaria jaegeri, Brachiaria kigeziensis, Brachiaria multiflora, Brachiaria semisterilis, Brachiaria tristachya, or combinations thereof.

12. The method as claimed in claim 1, wherein the herbicidal combination is applied jointly, or separately, or sequentially, or simultaneously to a plant or locus thereof to control from about 80% to about 100% of the weeds.

13. (canceled)

14. A herbicidal combination for controlling Brachiaria genus weeds, the herbicidal combination comprising:
(a) L-glufosinate, salts, esters, or combinations thereof; and
(b) at least one additional herbicide selected from the group consisting of protoporphyrinogen oxidase inhibitor herbicides, auxin herbicides, and combinations thereof.

15. A herbicidal composition for controlling Brachiaria genus weeds, the herbicidal composition comprising:
(a) L-glufosinate, salts, esters, or combinations thereof;
(b) at least one additional herbicide selected from the group consisting of protoporphyrinogen oxidase inhibitor herbicides, auxin herbicides, and combinations thereof; and
(c) at least one agrochemically acceptable excipient.
